(19) United States
(12) Patent Application Publication
(10) Pub. No.: US 2013/0155919 A1
(43) Pub. Date: Jun. 20, 2013

(54) METHOD OF POTENTIAL ROUTING, METHOD OF POTENTIAL SCHEDULING, AND MESH NODE

(71) Applicant: Sangsu Jung, Daejeon-city (KR)

(72) Inventor: Sangsu Jung, Daejeon-city (KR)

(73) Assignee: KOREA BASIC SCIENCE INSTITUTE, Daejeon-city (KR)

(21) Appl. No.: 13/407,881

(22) Filed: Feb. 29, 2012

(30) Foreign Application Priority Data
Dec. 20, 2011 (KR) 10-2011-0138066
Feb. 7, 2012 (KR) 10-2012-0012503

(51) Int. Cl. H04W 72/04; H04W 84/18

(52) U.S. Cl. 370/310

(57) ABSTRACT

A method of potential routing, a method of potential scheduling, and a mesh node are provided. Here, the mesh node includes a potential routing unit that transmits a data packet to a preset routing path by calculating a multiple potential, wherein the multiple potential indicates each potential of all destination nodes including a plurality of mesh nodes; and a potential scheduler that schedules a packet transmission order using the multiple potential.

### CROSS-REFERENCE TO RELATED APPLICATION

This application claims priority to and the benefit of Korean Patent Application Nos. 10-2011-0138066 and 10-2012-0012503 filed in the Korean Intellectual Property Office on Dec. 20, 2011 and Feb. 7, 2012, the entire contents of which are incorporated herein by reference.

### BACKGROUND OF THE INVENTION

(a) Field of the Invention

The present invention relates to a method of potential routing, a method of potential scheduling, and a mesh node.

(b) Description of the Related Art

According to conventional potential routing technology, potential of a plurality of mesh nodes is calculated, and potential of a plurality of gateway nodes is set.

Thereafter, when a data packet is transmitted at a specific node, potential and position information of one-hop neighbor nodes is requested and received, and a routing path is set according to the information. By transmitting a data packet to a single path or a multiple path according to such a routing path, a maintenance cost of a network path and handover delay of a moving mesh node are minimized.

Such conventional potential routing technology fixes a reflection ratio of a geographical element and a traffic element. Therefore, when a network traffic situation is dynamically changed, there is a limitation in selecting an inefficient path.

A conventional potential scheduling technique calculates potential of a plurality of mesh nodes and sets potential of a plurality of gateway nodes. Thereafter, when a data packet is transmitted at a specific node, potential and position information of one-hop neighbor nodes is requested and received and a packet transmission order is set according to the information.

By transmitting a data packet according to such a packet transmission order, delay is reduced and throughput is increased.

However, an existing potential scheduling technique reflects geographical information with only an initially designated ratio to queue difference-based scheduling that achieves throughput-optimal.

Thereby, when a network traffic situation is changed or when initial setting has an error, there is a scheduling problem that reduces achievable throughput.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of potential routing, a method of potential scheduling, and a mesh node having advantages of using multiple potential that is calculated by adjusting a reflection ratio of geographical information and traffic information according to a congestion degree of a network.

An exemplary embodiment of the present invention provides a method of potential routing of one of a plurality of mesh nodes that form a wireless ad-hoc mesh network, the method including: calculating multiple potential, wherein the multiple potential indicates potential for each of all destination nodes including the plurality of mesh nodes; and transmitting a data packet to a preset routing path using the multiple potential.

The calculating of multiple potential may include applying a length and dynamic parameter of queue in a standby state for transmission when calculating the multiple potential, wherein the dynamic parameter represents potential sensitiveness according to a length change of queue in a standby state for transmission and the length of queue in a standby state for transmission is calculated through an applied function value.

The calculating of multiple potential may include minimizing a value of the dynamic parameter when the length of queue in a standby state for transmission is a previously defined threshold value or less and increasing a value of the dynamic parameter in proportional to the length of queue in a standby state for transmission when the length of queue in a standby state for transmission exceeds a previously defined threshold value.

The calculating of multiple potential may include determining whether a previously defined potential calculation condition is satisfied; generating, if a previously defined potential calculation condition is not satisfied, at least one virtual node until a triangle having a calculable potential value is formed within a transmission area; and generating, if a previously defined potential calculation condition is satisfied or after generating at least one virtual node, the at least one virtual node and calculating the multiple potential.

The method may further include receiving the multiple potential of each of the neighbor nodes from the neighbor nodes before the calculating of multiple potential,

the transmitting of a data packet may include selecting a neighbor node having a routing path having a relatively largest difference between potential of a specific destination node and potential of the neighbor nodes; and transmitting the data packet to the selected neighbor node.

The method may further include broadcasting a hello message in which the multiple potential is recorded to neighbor nodes after the calculating of multiple potential,

wherein the receiving of the multiple potential may include receiving a hello message in which multiple potential of each of the neighbor nodes is recorded.

The hello message may include the multiple potential and three-dimensional position information.

The method may further include: forming a potential management table including a destination field, a potential field thereof, a potential field of a neighbor node, a position information field of a neighbor node, and a queue information field thereof; and updating the multiple potential and potential and position information of a neighbor node that is acquired from the hello message to the potential management table.

Another embodiment of the present invention provides a method of potential scheduling of one of a plurality of mesh nodes that form a wireless ad-hoc mesh network, the method including: calculating potential by a potential equation to which a dynamic parameter is applied, wherein the dynamic parameter represents potential sensitiveness according to a length change of queue in a standby state for transmission; receiving potential of one-hop neighbor nodes that are calculated by the potential calculation equation; calculating a difference between potential of the one mesh node and potential of one-hop neighbor node and a potential difference between the one-hop neighbor node and a neighbor node of the one-hop neighbor node; and scheduling a packet transmission order based on the difference between potentials.

The scheduling of a packet transmission order may include aligning the differences between potentials; and providing a channel access priority to a link having a largest difference between potentials.

The method may further include exchanging a difference between potentials that are calculated at the calculating of a difference with neighbor nodes corresponding to the specific destination.

Yet another embodiment of the present invention provides a mesh node that forms a wireless ad-hoc mesh network, the mesh node including: a potential routing unit that transmits a data packet to a preset routing path by calculating a multiple potential, wherein the multiple potential indicates each potential of all destination nodes including a plurality of mesh nodes; and a potential scheduler that schedules a packet transmission order using the multiple potential.

The potential routing unit may apply a length and dynamic parameter of queue in a standby state for transmission when calculating the multiple potential, wherein the dynamic parameter represents potential sensitiveness according to a length change of queue in a standby state for transmission and the length of queue in a standby state for transmission is calculated through an applied function value.

The potential routing unit may minimize a value of the dynamic parameter when the length of queue in a standby state for transmission is a previously defined threshold value or less and increase a value of the dynamic parameter in proportional to the length of queue in a standby state for transmission when the length of queue in a standby state for transmission exceeds a previously defined threshold value.

The potential routing unit may determine whether a previously defined potential calculation condition is satisfied; generate, if a previously defined potential calculation condition is not satisfied, at least one virtual node until a triangle having a calculable potential value is formed within a transmission area; and generates, if a previously defined potential calculation condition is satisfied or after generating at least one virtual node, the at least one virtual node and calculates the multiple potential.

The potential routing unit may receive the multiple potential of each of neighbor nodes from the neighbor nodes, select a neighbor node having a routing path having a relatively largest difference between potential of a specific destination node and potential of the neighbor nodes, and transmit the data packet to the selected neighbor node.

The potential routing unit may broadcast a hello message in which the multiple potential is recorded to neighbor nodes and receives a hello message in which multiple potential of each of the neighbor nodes is recorded.

The potential routing unit may form a potential management table including a destination field, a potential field thereof, a potential field of a neighbor node, a position information field of a neighbor node, and a queue information field thereof and update the calculated potential and information of a neighbor node that is acquired from a hello message to the potential management table.

The potential scheduler may schedule a packet transmission order by calculating a difference between potential that is calculated by a potential calculation equation to which the dynamic parameter is applied and potentials of one-hop neighbor nodes and a difference between potentials of the one-hop neighbor nodes and neighbor nodes of the one-hop neighbor nodes.

The potential scheduler may provide a channel access priority to a link having a largest difference between the potentials.

The potential scheduler may exchange a difference between potentials with neighbor nodes corresponding to a specific destination.

According to an exemplary embodiment of the present invention, a method of routing dynamic potential can adoptively form an optimal routing path even in a network environment in which a configuration of traffic or a node is dynamically changed through a dynamic parameter.

Further, by supplementing a drawback of characterized conventional potential routing for few fixed destination nodes, as in a wireless mesh network, a plurality of random destination node environments may be also processed.

Further, when a network load is in a slight level through a dynamic parameter of a routing index that can adjust a geographical element and a traffic element, a routing path is set adjacent to geographical information-based routing, and when a network load is excessive, a routing path is set adjacent to back pressure routing. Thereby, delay of packet transmission is minimized, and network throughput is maximized.

Further, performance deterioration according to a network topology change is prevented through a multiple potential field for each destination, and a flexible path for each packet is provided.

Further, by scheduling based on a dynamic parameter, when a network load is in a slight level, a channel access priority is given to a packet that can go a farthest distance within a predetermined time period, and when a network load is in an excessive level, by determining a channel access order similarly to back pressure scheduling in consideration of only a traffic element, data are transmitted in a direction that can reduce a load of an entire network, and thus a network throughput can be more quickly optimized.

### BRIEF DESCRIPTION OF THE DRAWINGS

FIG. 1 is a diagram illustrating a wireless ad-hoc mesh network according to an exemplary embodiment of the present invention.

FIG. 2 is a diagram illustrating a configuration of a potential information management table according to an exemplary embodiment of the present invention.

FIG. 3 is a diagram illustrating a configuration of a hello message according to an exemplary embodiment of the present invention.

FIG. 4 is a block diagram illustrating an internal configuration of a mesh node according to an exemplary embodiment of the present invention.

FIG. 5 is a flowchart illustrating a potential calculation process according to an exemplary embodiment of the present invention.

FIG. 6 is a diagram illustrating a potential calculation condition according to an exemplary embodiment of the present invention.

FIG. 7 is a diagram illustrating a potential field convergent example of a random destination node according to an exemplary embodiment of the present invention.

FIG. 8 is a flowchart illustrating a method of potential routing according to an exemplary embodiment of the present invention.

FIG. 9 is a flowchart illustrating a method of potential scheduling according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

Hereinafter, a method of potential routing, a method of potential scheduling, and a mesh node according to an exemplary embodiment of the present invention will be described in detail with reference to the drawings.

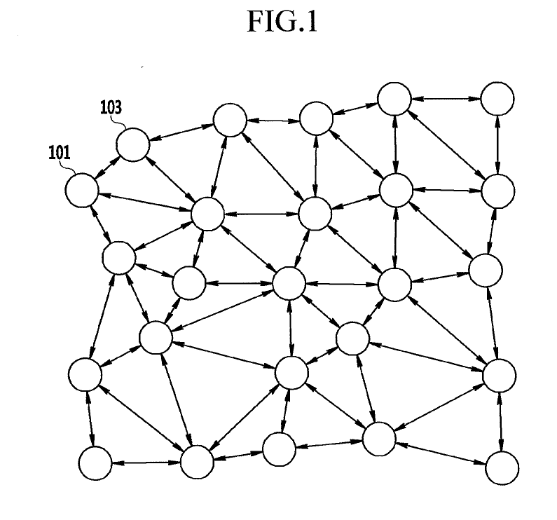

FIG. 1 is a diagram illustrating a wireless ad-hoc mesh network according to an exemplary embodiment of the present invention.

Referring to FIG. 1, the wireless ad-hoc mesh network is formed with a plurality of mesh nodes 100. Such a plurality of mesh nodes 100 may include a node-B, a base station, a site controller, an access point (AP), a wireless transmitting and receiving unit, a transceiver, a user equipment, a mobile station, a fixed or moving subscriber unit, and a random interface device in a wireless environment.

In the wireless ad-hoc mesh network, a plurality of mesh nodes 100 transmit a data packet from one mesh node 101 to another mesh node 103. In this case, one mesh node 101 selects another mesh node 103 to transmit a data packet based on potential information.

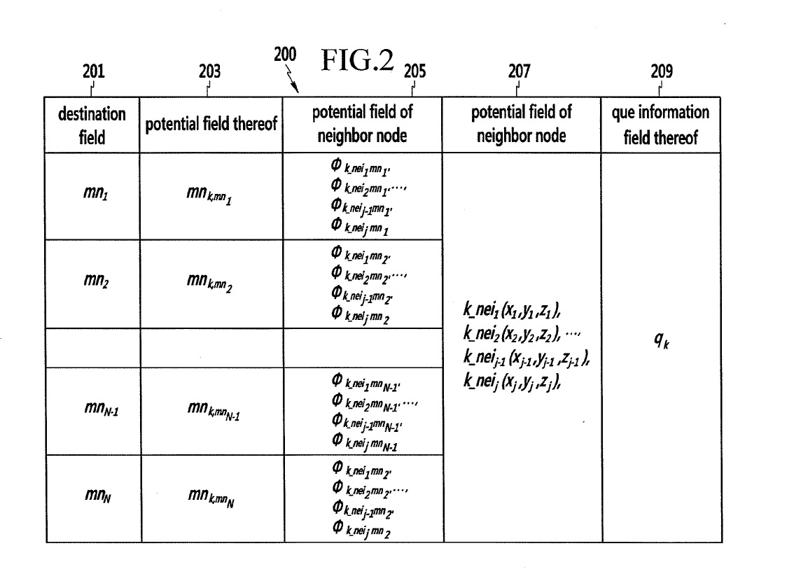

Therefore, a plurality of mesh nodes 100 each manage potential information, and such potential information may be formed in a table form, as shown in FIG. 2.

FIG. 2 is a diagram illustrating a configuration of a potential information management table according to an exemplary embodiment of the present invention.

Referring to FIG. 2, a potential information management table 200 is formed with a plurality of fields 201, 203, 205, 207, and 209. Such a plurality of fields 201, 203, 205, 207, and 209 each include a destination field 201, a potential field 203 thereof, a potential field 205 of a neighbor node, a position information field 207 of a neighbor node, and a queue information field 209 thereof.

The destination field 201 includes the N number of mesh nodes mn₁, mn₂, . . . , mn_{N-1}, and mn_{N} that are included in the wireless ad-hoc mesh network of FIG. 1.

Here, in the one mesh node 101, a destination node may be one of the N number of mesh nodes that are included in the destination field 201 and is determined according to a request of an application that is executed in the one mesh node 101.

The potential field 203 of the one mesh node 101 includes potential thereof corresponding to each destination node that is included in the destination field 201. Such potential is an index for determining routing and scheduling of a packet and is calculated by Equation 1.

The potential field 205 of a neighbor node includes potential of a neighbor node corresponding to each destination node that is included in the destination field 201.

The position information field 207 of a neighbor node includes position information of a neighbor node corresponding to each destination node that is included in the destination field 201.

The queue information field 209 of the one mesh node 101 includes queue information qₖ thereof.

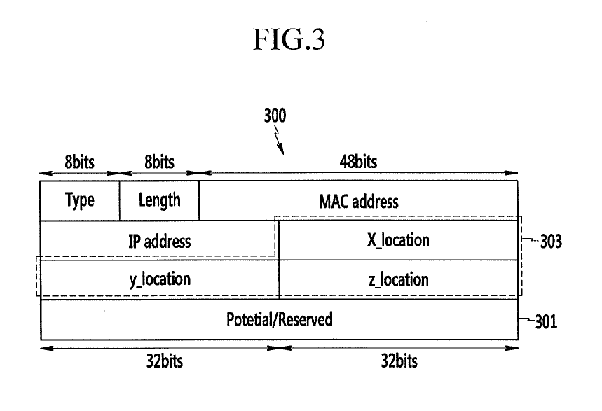

In this case, in order to manage potential information, each mesh node periodically exchanges potential information with neighbor nodes through a hello message. Such a hello message is formed, as shown in FIG. 3.

FIG. 3 is a diagram illustrating a configuration of a hello message according to an exemplary embodiment of the present invention.

Referring to FIG. 3, a hello message 300 includes a type, a length, an MAC address, an IP address, a potential 301, and position information (x_location, y_location, and, z_location) 303 of 8 bits.

In this case, the potential 301 includes potential of one mesh node 101 corresponding to each destination node that is included in the destination field 201 of FIG. 2.

Here, in order to reduce data information processing overhead, the one mesh node 101 can reduce a weight of potential thereof corresponding to each destination node by various compressing method.

Further, only when the one mesh node 101 receives a potential request for a specific destination node from neighbor nodes, the one mesh node 101 may transmit potential thereof.

Further, the position information (x_location, y_location, and z_location) 303 includes position information of the one mesh node 101. In this case, when position information of the one mesh node 101 is not changed, the one mesh node 101 may limitedly transmit position information thereof.

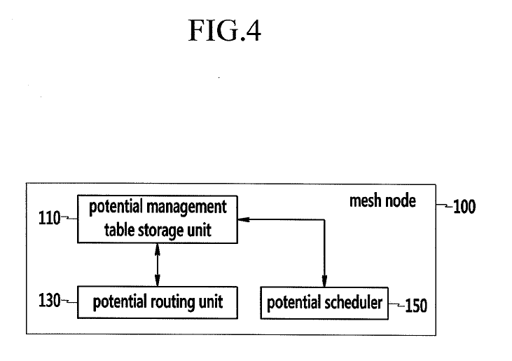

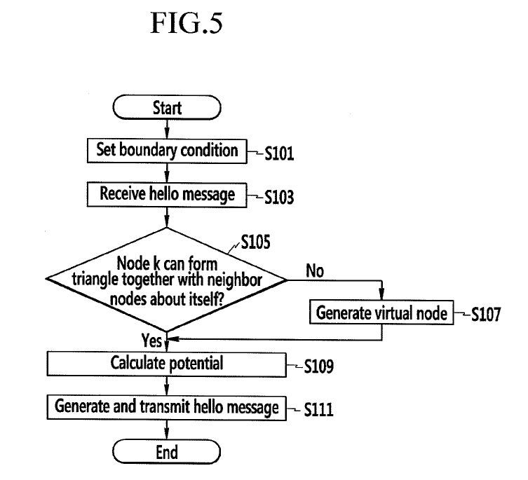

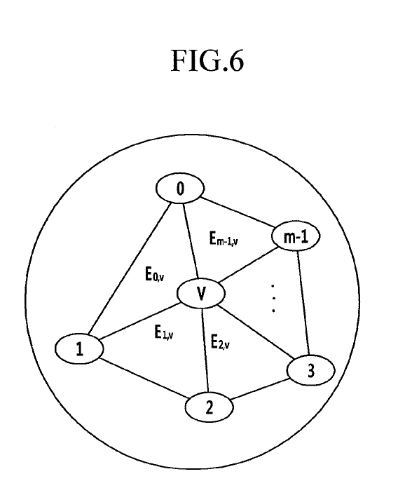

The plurality of mesh nodes 100 may have an internal configuration of FIG. 4.

FIG. 4 is a block diagram illustrating an internal configuration of a mesh node according to an exemplary embodiment of the present invention.

Referring to FIG. 4, the mesh node 100 includes a potential management table storage unit 110, a potential routing unit 130, and a potential scheduler 150.

The potential management table storage unit 110 stores the potential management table of FIG. 2.

The potential routing unit 130 calculates multiple potential and transmits a data packet to a preset routing path. Here, multiple potential is each potential of all destination nodes, and all destination nodes become a plurality of mesh nodes 100 that form a wireless ad-hoc mesh network.

The potential scheduler 150 schedules a packet transmission order using multiple potential that is stored at the potential management table storage unit 110.

In this case, a detailed operation of each of the potential routing unit 130 and the potential scheduler 150 will be described hereinafter with reference to the drawings.

Here, the potential routing unit 130 performs potential routing using multiple potential, and such a method of potential routing includes step of calculating multiple potential and step of transmitting a data packet to a preset routing path using such multiple potential.

First, FIG. 5 is a flowchart illustrating a potential calculation process according to an exemplary embodiment of the present invention, i.e., is a flowchart illustrating step of calculating multiple potential.

Referring to FIG. 5, the potential routing units 130 of a plurality of mesh nodes 100 each set a boundary condition (S101), and allocate initial potential to 0, but for a case where the potential routing unit 130 is used as the destination, potential for the destination is allocated as predefined minimum potential (e.g., −1).

Here, a term of a boundary condition, which is a condition that is applied to a boundary in order to satisfy a specific phenomenon of an arbitrary system, is applied to a network system.

That is, the boundary condition largely includes three conditions of a Dirichlet boundary condition in which a predetermined value is given on the boundary, a Neumann boundary condition in which a predetermined vertical differential value is given on the boundary, and a mixed boundary condition (Cauchy boundary condition) in which all of a predetermined value and a vertical differential value are given on the boundary.

By applying such a concept to a network system, when boundary nodes existing on a boundary of network topology have a predetermined potential value, a Dirichlet boundary condition is satisfied, when boundary nodes existing on a boundary of network topology have a change amount of a predetermined potential value, a Neumann boundary condition is satisfied, and when boundary nodes existing on a boundary of network topology have a predetermined potential value and a change amount of a predetermined potential value, a mixed boundary condition (Cauchy boundary condition) is satisfied, and these become a boundary node condition of a network system.

The potential routing units 130 of a plurality of mesh nodes 100 each receive a hello message from neighbor nodes (S103). The potential routing units 130 determine whether the hello message satisfies a potential calculation condition (S105).

Here, the potential calculation condition represents whether Equation 1 to be described later can be calculated, and Equation 1 represents that one mesh node (k) 101 should be able to form a triangle together with neighbor nodes about the one mesh node (k) 101 and is shown in FIG. 6.

FIG. 6 is a diagram illustrating a potential calculation condition according to an exemplary embodiment of the present invention.

Referring to FIG. 6, a random node V forms one triangle together with continuously positioned one-hop neighbor node 0 and one-hop neighbor node 1. Further, the random node V forms one triangle together with continuously positioned one-hop neighbor node 1 and one-hop neighbor node 2. Further, the random node V forms one triangle together with continuously positioned one-hop neighbor node 2 and one-hop neighbor node 3. By repeating this, the random node V is enclosed by triangles.

In this case, when one-hop neighbor nodes are positioned on a straight line, or when the number of one-hop neighbor nodes is 1, a triangle cannot be formed.

Therefore, at step S105, it is determined whether each of a plurality of mesh nodes 100 forms a triangle of FIG. 6 using the mesh node 101 as the reference.

Here, when a potential calculation condition is not satisfied at step S105, i.e., when positions or the number of neighbor nodes enclosing the potential routing unit 130 is insufficient, the potential routing unit 130 of a plurality of mesh nodes 100 generates a virtual node (S107).

In this case, at least one virtual node is disposed to form a triangle with one mesh node (k) 101, and a virtual node having a potential value that is obtained by interpolation of a potential value of one mesh node (k) 101 and an appropriate random constant may be disposed.

Further, after a potential calculation condition is satisfied at step S105 or after at least one virtual node is generated at step S107, the potential routing units 130 of the plurality of mesh nodes 100 each calculate potential thereof (S109).

Here, the potential routing units 130 of the plurality of mesh nodes 100 use Equation 1 in order to calculate potential thereof.

$${φ}_{k , {mn}_{d}} = \frac{{\sum }_{s = 0}^{j - 1} \frac{\begin{matrix}( \begin{matrix}{φ}_{{k\_nei}_{s} {mn}_{d}} {\vec{r}}_{k , {k\_nei}_{s - 1} {mn}_{d}} - \\ {φ}_{{k\_nei}_{s - 1} {mn}_{d}} {\vec{r}}_{k , {k\_nei}_{s} {mn}_{d}}\end{matrix} ) \cdot \\ ( {\vec{r}}_{k , {k\_nei}_{s - 1} {mn}_{d}} - {\vec{r}}_{k , {k\_nei}_{s} {mn}_{d}} )\end{matrix}}{{A}_{s}} + α ( {q}_{k} ) \cdot {q}_{k}}{{\sum }_{s = 0}^{j - 1} \frac{{‖ {\vec{r}}_{k , {k\_nei}_{s - 1} {mn}_{d}} - {\vec{r}}_{k , {k\_nei}_{s} {mn}_{d}} ‖}^{2}}{{A}_{s}}} \qquad ( Equation 1 )$$

where φₖ,mn_{d} is potential for a destination node mn_{d} of a mesh node k. Such potential represents that a mesh node k has potential for all destination nodes mn_{d} and is defined by multiple potential.

qₖ is a length of queue in a standby state for transmission at the mesh node k.

φₖ_{_{—}}ₙₑᵢ_{ₛ₋₁}ₙₘ_{_{d}} is potential of a (s−1)st one-hop neighbor node k_neiₛ₋₁nm_{d}.

φₖ_{_{—}}ₙₑᵢ_{ₛ}ₙₘ_{_{d}} is potential of an sth one-hop neighbor node k_neiₛmn_{d}.

\vec{r}_{k,k}_{_{—}}ₙₑᵢ_{_{s 1}}ₘₙ_{_{d}} is distance information of an (s−1)st one-hop neighbor node k_neiₛ₋₁mn_{d} and a mesh node k.

\vec{r}_{k,k}_{_{—}}ₙₑᵢ_{ₛ}ₙₘ_{_{d}} is distance information of an sth one-hop neighbor node k_neiₛnm_{d} and a mesh node k.

A_{S} is an area of a triangle that is formed by an (s−1)st one-hop neighbor node k_nei_{d-1}mn_{d}, an S-th one-hop neighbor node k_neiₛmn_{d}, and a mesh node k. That is, in FIG. 6, an area of a triangle that encloses a periphery of a random node V and includes an area of triangles of the total j number.

α(qₖ) is a dynamic parameter representing sensitiveness of potential according to a change of a length qₖ of queue in a standby state for transmission at the mesh node k, and here, the dynamic parameter is a value changing according to a length qₖ of queue in a standby state for transmission. That is, α(qₖ) is a degree in which a length qₖ of queue in a standby state for transmission in a mesh node k is reflected to potential.

α(qₖ) may be represented by Equation, as shown in Table 1.

Table 1 is a function setting example of α(qₖ), and qₖ is represented as qᵥⁿ.

TABLE 1

| Name of Function | Equation |
|---|---|
| Constant function | F_{c} |
| Step function | $\frac{{F}_{s}}{Ns - 1} \cdot [ \frac{Ns \cdot {q}_{v}^{n}}{{Q}_{s}} ]$ |
| Gaussian function | F_{g} · e^{-A(q}_{ᵥ}^{ⁿ}^{-Q}_{_{g}}⁾ |

As shown in Table 1, because α(qₖ) is a function of a queue value, a value of α(qₖ) changes according to a change of a queue value.

Thereafter, each of the potential routing units 130 of the plurality of mesh nodes 100 reflects potential that is calculated at step S109 to a hello message and transmits the hello message to neighbor nodes through one-hop broadcast (S111).

In this case, before step S111, step in which the potential routing units 130 of the plurality of mesh nodes 100 compare a length of queue in a standby state for transmission and a previously defined threshold value may be further included. In this case, if a length of queue in a standby state for transmission is a previously defined threshold value or less, step of minimizing a value, of a dynamic parameter may be further included.

Further, if a length of queue in a standby state for transmission exceeds a previously defined threshold value, step of increasing a value of the dynamic parameter in proportional to the length of queue in a standby state for transmission may be further included.

Here, a length of queue in a standby state for transmission in a random node k sustains a predetermined value, i.e., a previously defined threshold value or less and thus network traffic is a network capacity or less at a periphery of a random node k. Therefore, even if a load is not balanced, a network performance is not influenced.

If a length of queue in a standby state for transmission in a random node k exceeds and continues to increase a predetermined value, i.e., a previously defined threshold value, traffic is excessively scattered at a periphery of a random node k. If a load is not balanced, a confusion area occurs and an entire network performance is deteriorated.

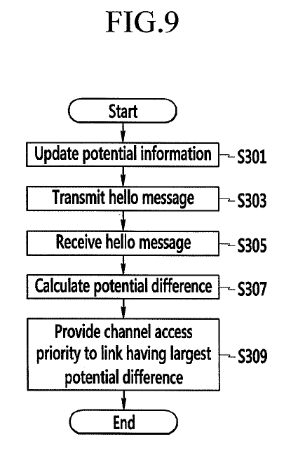

A wireless ad-hoc mesh network uses wireless medium in order to transmit a packet, and the wireless medium is a sharing resource. That is, when a specific node performs transmission, other nodes are resources having characteristics that cannot be transmitted. If at least two nodes simultaneously transmit a packet, a wireless channel state is aggravated due to packet collision or packet interference and thus a packet cannot be transmitted. For an efficient medium access control to a wireless sharing resource, in the present invention, a dynamic scheduling method using potential information will be described later with reference to FIG. 9.

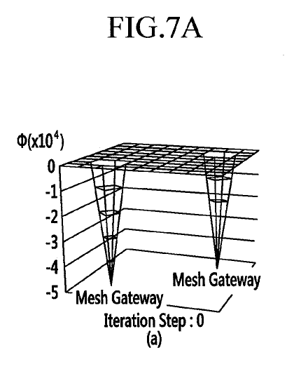

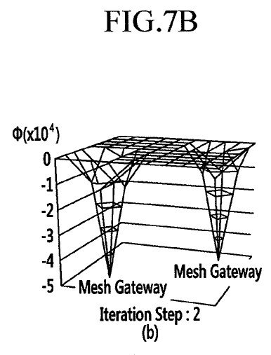

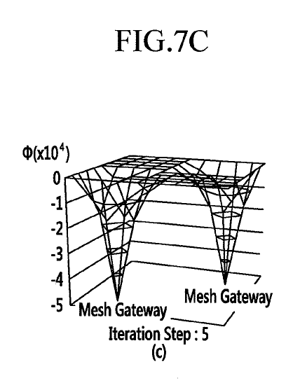

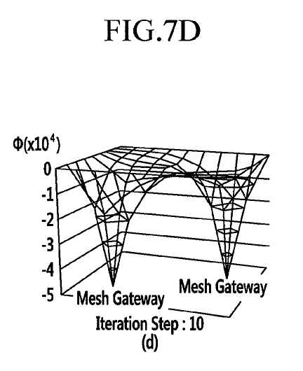

FIG. 7 is a diagram illustrating a potential field convergent example of a random destination node according to an exemplary embodiment of the present invention.

Here, FIG. 7A is a graph illustrating entire network potential distribution of a state in which only initial setting is performed for a plurality of mesh nodes 100 in a state in which traffic does not exist.

Further, FIG. 7B is a graph illustrating entire network potential distribution of a state in which a plurality of mesh nodes 100 execute twice Equation 1 in a state in which traffic does not exist. Further, FIG. 7C is a graph illustrating entire network potential distribution of a state in which a plurality of mesh nodes 100 execute five times Equation 1 in a state in which traffic does not exist.

Further, FIG. 7D is a graph illustrating entire network potential distribution of a state in which a plurality of mesh nodes 100 execute ten times Equation 1 in a state in which traffic does not exist.

In this case, potential distribution is an example of an assumption in which all mesh nodes 100 have the same destination node.

In an initial stage of a network configuration, a data packet is not transmitted, and a multiple potential field that is converged for each destination node may be formed by repeating a process of FIGS. 7B to 7D so that each mesh node 100 has appropriate potential through only a hello message.

Because the number of repetition that is executed until forming a converged potential field is very small as about 30-50 times in a wireless ad-hoc mesh network that is formed with 100 mesh nodes, a potential field for transmitting a data packet may be provided for a short time.

In this way, a dynamic routing process for transmitting a data packet will be described based on a provided potential field.

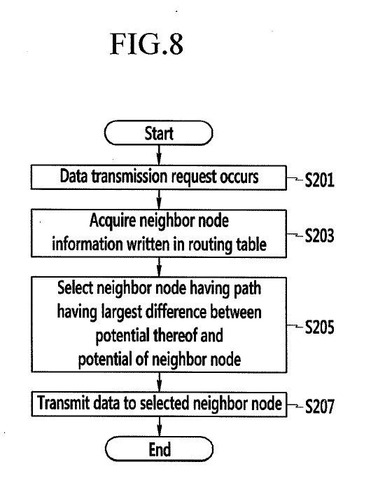

FIG. 8 is a flowchart illustrating a method of potential routing according to an exemplary embodiment of the present invention and is a flowchart illustrating step of transmitting a data packet to a preset routing path using multiple potential.

Referring to FIG. 8, when a data packet transmission request occurs (S201), the potential routing units 130 of the plurality of mesh nodes 100 acquire neighbor node information that is recorded in a routing table (not shown) (S203). Here, the routing table (not shown) includes neighbor node information of each destination node and may be formed, as shown in Table 2.

TABLE 2

| Destination | Gateway | Genmask | Flags | Metric | Ref | Use | Iface |
|---|---|---|---|---|---|---|---|
| 192.168.2.40 | 192.168.2.120 | 255.255.255.255 | UGH | 2 | 0 | 0 | eth2 |
| 192.168.2.90 | * | 255.255.255.255 | UH | 2 | 0 | 0 | eth2 |
| 192.168.2.120 | * | 255.255.255.255 | UH | 2 | 0 | 0 | eth2 |
| 192.168.2.0 | * | 255.255.255.0 | U | 0 | 0 | 0 | eth2 |
| 192.168.60.0 | * | 255.255.255.0 | U | 0 | 0 | 0 | br0 |
| 169.254.0.0 | * | 255.255.255.0 | U | 0 | 0 | 0 | br0 |
| 127.0.0.0 | * | 255.0.0.0 | U | 0 | 0 | 0 | lo |
| Default | 192.168.2.90 | 0.0.0.0 | UG | 2 | 0 | 0 | eth2 |

The potential routing units 130 of the plurality of mesh nodes 100 select a routing path to transmit a data packet based on neighbor node information that is acquired at step S203 (S205). Such a routing path is formed with neighborhood nodes and determines a neighbor node to transmit a data packet through Equation 2.

$$arg {min}_{n ∈ {N}_{k}} \frac{φ ( n ) - φ ( k )}{‖ {\vec{r}}_{n} - {\vec{r}}_{k} ‖} \qquad ( Equation 2 )$$

According to Equation 2, the routing path is formed with neighbor nodes having a path having a largest potential difference between potential of a destination node and potential of neighbor nodes at a position of the destination node of each data packet and a position of neighbor nodes and transmits a data packet to such neighbor nodes (S207).

Here, φ(n) and φ(k) are calculated through Equation 1, and a reflection ratio of geographical information and traffic information of routing may be appropriately formed with characteristics of a dynamic parameter α(qₖ) that is applied to Equation 1.

In this case, traffic information is simply a length qₖ of queue in a standby state for transmission. That is, a reflection ratio of traffic information is adjusted by α(qₖ), and a reflection degree of an accurate numerical value becomes •α(qₖ)/a denominator of Equation 1′.

FIGS. 5 and 8 are separately described, but may be performed with a series of procedures by the potential routing unit 130.

In this case, after performing step of FIGS. 5 and 8, step in which the potential routing unit 130 forms the potential management table 200 of FIG. 2 and updates multiple potential and potential and position information of a neighbor node that acquires from a hello message to the potential management table 200 may be further included.

FIG. 9 is a flowchart illustrating a method of potential scheduling according to an exemplary embodiment of the present invention.

Referring to FIG. 9, the potential schedulers 150 of the plurality of mesh nodes 100 each update potential information at every unit time (S301). The potential scheduler 150 transmits updated potential information to one-hop neighbor node through a hello message (S303).

Thereafter, each of the potential schedulers 150 of the plurality of mesh nodes 100 acquires potential information of each of one-hop neighbor nodes through a hello message that is received from one-hop neighbor nodes (S305).

In this case, a potential difference between a neighbor node and a two-hop neighbor node is also included in potential information that receives from one-hop neighbor nodes.

Each of the potential scheduler 150 of the plurality of mesh nodes 100 calculates a potential difference between the potential scheduler 150 and one-hop neighbor node (S307). The potential scheduler 150 provides a channel access priority to a link having the largest potential difference (S309). That is, each of the potential scheduler 150 of the plurality of mesh nodes 100 acquires a channel access priority of a link that can use within two-hops based on collected potential information. When the potential scheduler 150 includes a link having the largest potential difference, a corresponding moving node limits use of other links through a CTS packet.

The above-described exemplary embodiment of the present invention may be not only embodied through an apparatus and method but also embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of potential routing of one of a plurality of mesh nodes that form a wireless ad-hoc mesh network, the method comprising:
calculating multiple potential, wherein the multiple potential indicates potential for each of all destination nodes comprising the plurality of mesh nodes; and
transmitting a data packet to a preset routing path using the multiple potential.

2. The method of claim 1, wherein the calculating of multiple potential comprises applying a length and dynamic parameter of queue in a standby state for transmission when calculating the multiple potential, wherein the dynamic parameter represents potential sensitiveness according to a length change of queue in a standby state for transmission and the length of queue in a standby state for transmission is calculated through an applied function value.

3. The method of claim 2, wherein the calculating of multiple potential comprises minimizing a value of the dynamic parameter when the length of queue in a standby state for transmission is a previously defined threshold value or less and increasing a value of the dynamic parameter in proportional to the length of queue in a standby state for transmission when the length of queue in a standby state for transmission exceeds a previously defined threshold value.

4. The method of claim 2, wherein the calculating of multiple potential comprises
determining whether a previously defined potential calculation condition is satisfied;
generating, if a previously defined potential calculation condition is not satisfied, at least one virtual node until a triangle having a calculable potential value is formed within a transmission area; and
generating, if a previously defined potential calculation condition is satisfied or after generating at least one virtual node, the at least one virtual node and calculating the multiple potential.

5. The method of claim 2, wherein the calculating of multiple potential comprises calculating the multiple potential through the following Equation.
$${φ}_{k , {mn}_{d}} = \frac{{\sum }_{s = 0}^{j - 1} \frac{\begin{matrix}( \begin{matrix}{φ}_{{k\_nei}_{s} {mn}_{d}} {\vec{r}}_{k , {k\_nei}_{s - 1} {mn}_{d}} - \\ {φ}_{{k\_nei}_{s - 1} {mn}_{d}} {\vec{r}}_{k , {k\_nei}_{s} {mn}_{d}}\end{matrix} ) \cdot \\ ( {\vec{r}}_{k , {k\_nei}_{s - 1} {mn}_{d}} - {\vec{r}}_{k , {k\_nei}_{s} {mn}_{d}} )\end{matrix}}{{A}_{s}} + α ( {q}_{k} ) \cdot {q}_{k}}{{\sum }_{s = 0}^{j - 1} \frac{{‖ {\vec{r}}_{k , {k\_nei}_{s - 1} {mn}_{d}} - {\vec{r}}_{k , {k\_nei}_{s} {mn}_{d}} ‖}^{2}}{{A}_{s}}}$$
φₖ,mn_{d} is potential of a destination node mn_{d} of a mesh node k, qₖ is a length of queue in a standby state for transmission in a mesh node k, φₖ_{_{—}}ₙₑᵢ_{ₛ₋₁}ₙₘ_{_{d}} is potential of an (s−1)st one-hop neighbor node node k_neiₛmn_{d}, φₖ_{_{—}}ₙₑᵢ_{ₛ}ₘₙ_{_{d}} is potential of an sth one-hop neighbor node k_neiₛmn_{d}, \vec{r}_{k,k}_{_{—}}ₙₑᵢ_{_{s 1}}ₘₙ_{_{d}} is distance information of an (s−1)st one-hop neighbor node k_neiₛ₋₁mn_{d} and a mesh node k, \vec{r}_{k,k}_{_{—}}ₙₑᵢ_{ₛ}ₘₙ_{_{d}} is distance information of an sth one-hop neighbor node k_neiₛnm_{d} and a mesh node k_neiₛmn_{d} and a mesh node k, A_{S} is an area of a triangle that is formed by an (s−1)st one-hop neighbor node k_neiₛ₋₁mn_{d} and an sth one-hop neighbor node k_neiₛnm_{d} and a mesh node k, and α(qₖ) is a dynamic parameter representing sensitiveness of potential according to a change of a length qₖ of queue in a standby state for transmission in a mesh node k.

6. The method of claim 1, further comprising receiving the multiple potential of each of the neighbor nodes from the neighbor nodes before the calculating of multiple potential,
the transmitting of a data packet comprises
selecting a neighbor node having a routing path having a relatively largest difference between potential of a specific destination node and potential of the neighbor nodes; and
transmitting the data packet to the selected neighbor node.

7. The method of claim 6, wherein the selecting of a neighbor node comprises selecting the neighbor node through the following Equation.
$$arg {min}_{n ∈ {N}_{k}} \frac{φ ( n ) - φ ( k )}{‖ {\vec{r}}_{n} - {\vec{r}}_{k} ‖}$$
wherein φ(n) is potential of a neighbor node n, φ(k) is potential of the one mesh node k, Nₖ is a plurality of mesh nodes constituting the wireless ad-hoc mesh network, \vec{r}ₙ is a position of a neighbor node n, and \vec{r}ₖ is a position of the one mesh node k.

8. The method of claim 6, further comprising broadcasting a hello message in which the multiple potential is written to neighbor nodes after the calculating of multiple potential,
wherein the receiving of the multiple potential comprises receiving a hello message in which multiple potential of each of the neighbor nodes is recorded.

9. The method of claim 8, wherein the hello message comprises the multiple potential and three-dimensional position information.

10. The method of claim 9, further comprising:
forming a potential management table comprising a destination field, a potential field thereof, a potential field of a neighbor node, a position information field of a neighbor node, and a queue information field thereof; and
updating the multiple potential and potential and position information of a neighbor node that is acquired from the hello message to the potential management table.

11. A method of potential scheduling of one of a plurality of mesh nodes that form a wireless ad-hoc mesh network, the method comprising:
calculating potential by a potential equation to which a dynamic parameter is applied, wherein the dynamic parameter represents potential sensitiveness according to a length change of queue in a standby state for transmission;
receiving potential of one-hop neighbor nodes that are calculated by the potential calculation equation;
calculating a difference between potential of the one mesh node and potential of one-hop neighbor node and a potential difference between the one-hop neighbor node and a neighbor node of the one-hop neighbor node; and
scheduling a packet transmission order based on the difference between potentials.

12. The method of claim 11, wherein the scheduling of a packet transmission order comprises
aligning the differences between potentials; and
providing a channel access priority to a link having a largest difference between potentials.

13. The method of claim 11, further comprising exchanging differences between potentials that are calculated at the calculating of a difference with neighbor nodes corresponding to the specific destination.

14. A mesh node that forms a wireless ad-hoc mesh network, the mesh node comprising:
a potential routing unit that transmits a data packet to a preset routing path by calculating a multiple potential, wherein the multiple potential indicates each potential of all destination nodes comprising a plurality of mesh nodes; and
a potential scheduler that schedules a packet transmission order using the multiple potential.

15. The mesh node of claim 14, wherein the potential routing unit applies a length and dynamic parameter of queue in a standby state for transmission when calculating the multiple potential, wherein the dynamic parameter represents potential sensitiveness according to a length change of queue in a standby state for transmission and the length of queue in a standby state for transmission is calculated through an applied function value.

16. The mesh node of claim 15, wherein the potential routing unit minimizes a value of the dynamic parameter when the length of queue in a standby state for transmission is a previously defined threshold value or less and increases a value of the dynamic parameter in proportional to the length of queue in a standby state for transmission when the length of queue in a standby state for transmission exceeds a previously defined threshold value.

17. The mesh node of claim 15, wherein the potential routing unit determines whether a previously defined potential calculation condition is satisfied; generates, if a previously defined potential calculation condition is not satisfied, at least one virtual node until a triangle having a calculable potential value is formed within a transmission area; and generates, if a previously defined potential calculation condition is satisfied or after generating at least one virtual node, the at least one virtual node and calculates the multiple potential.

18. The mesh node of claim 15, wherein the potential routing unit receives the multiple potential of each of neighbor nodes from the neighbor nodes, selects a neighbor node having a routing path having a relatively largest difference between potential of a specific destination node and potential of the neighbor nodes, and transmits the data packet to the selected neighbor node.

19. The mesh node of claim 15, wherein the potential routing unit broadcasts a hello message in which the multiple potential is recorded to neighbor nodes and receives a hello message in which multiple potential of each of the neighbor nodes is recorded.

20. The mesh node of claim 19, wherein the potential routing unit forms a potential management table comprising a destination field, a potential field thereof, a potential field of a neighbor node, a position information field of a neighbor node, and a queue information field thereof and updates the calculated potential and information of a neighbor node that is acquired from a hello message to the potential management table.

21. The mesh node of claim 14, wherein the potential scheduler schedules a packet transmission order by calculating a difference between potential that is calculated by a potential calculation equation to which the dynamic parameter is applied and potentials of one-hop neighbor nodes and a difference between potentials of the one-hop neighbor nodes and neighbor nodes of the one-hop neighbor nodes.

22. The mesh node of claim 21, wherein the potential scheduler provides a channel access priority to a link having a largest difference between the potentials.

23. The mesh node of claim 22, wherein the potential scheduler exchanges differences between potentials with neighbor nodes corresponding to a specific destination.
